(19) United States
(12) Patent Application Publication
(10) Pub. No.: US 2022/0236145 A1
(43) Pub. Date: Jul. 28, 2022

(54) SYSTEM AND METHOD FOR CONTAINMENT OF AEROSOL PARTICLES

(71) Applicants: THERMO ENVIRONMENTAL INSTRUMENTS LLC, Franklin, MA (US); LIFE TECHNOLOGIES CORPORATION, Carlsbad, CA (US)

(72) Inventors: Jeffrey AMBS, Foxborough, MA (US); Robert BAILEY, Bellingham, MA (US); Emily PEARCE, Somerville, MA (US)

(73) Assignees: THERMO ENVIRONMENTAL INSTRUMENTS LLC, Franklin, MA (US); LIFE TECHNOLOGIES CORPORATION, Carlsbad, CA (US)

(21) Appl. No.: 17/648,320

(22) Filed: Jan. 19, 2022

Related U.S. Application Data
(60) Provisional application No. 63/140,409, filed on Jan. 22, 2021.

(51) Int. Cl. G01N 1/22

(52) U.S. Cl. CPC G01N 1/2214; G01N 2001/2223

(57) ABSTRACT

An embodiment of a system is described that, comprises a containment assembly comprising a receptacle configured to hold a substrate, wherein the containment assembly is configured to extend the receptacle from a housing and retract receptacle into the housing; and an aerosol collector comprising a sample chamber, wherein the aerosol collector is configured to operatively couple to the containment assembly and receive the extended receptacle with the substrate in the sample compartment.

The present application claims the priority benefit from U.S. Patent Application Ser. No. 63/140,409, filed Jan. 22, 2021, which is hereby incorporated by reference herein in its entirety for all purposes.

### FIELD OF THE INVENTION

The present invention is generally directed to a system configured to capture aerosolized particles from a gas and minimize user exposure to the particles.

### BACKGROUND

It is generally appreciated that systems exist for the collection of aerosolized particles from air, examples of which are described in U.S. Pat. Nos. 6,435,043; 6,769,316; 6,867,413; and 6,898,990, each of which is hereby incorporated by reference herein in its entirety for all purposes. In general, the systems collect the aerosolized particles onto substrate material that then must be manually handled to remove for subsequent particle analysis.

It is also appreciated that some particles, particularly some types of biological material such as viral particles, may pose a health risk to individuals that come into contact with them. Further, manual contact with the substrate may add a source of contamination that will affect results intended to reflect to content of the particles in the sampled gas while also potentially exposing the system operator to hazardous materials.

Therefore, a need exists for a solution to remove and isolate the substrate material for particle analysis without the risk to the health of individuals as well as to sample integrity.

### SUMMARY

Systems, methods, and products to address these and other needs are described herein with respect to illustrative, non-limiting, implementations. Various alternatives, modifications and equivalents are possible.

An embodiment of a system is described that, comprises a containment assembly comprising a receptacle configured to hold a substrate, wherein the containment assembly is configured to extend the receptacle from a housing and retract receptacle into the housing; and an aerosol collector comprising a sample chamber, wherein the aerosol collector is configured to operatively couple to the containment assembly and receive the extended receptacle with the substrate in the sample compartment.

In some cases, the substrate is constructed of polyurethane foam and may be removeable from the receptacle. Also, the containment assembly may include a plunger mechanism configured to extend the receptacle from the housing and retract receptacle into the housing and may threadingly couple to the aerosol collector. In some instances, the housing can also threadingly couple to a cap.

The sample chamber may further be fluidically coupled to an inlet and an outlet, where the sample chamber is configured to receive a gas flow from the inlet and exhaust the gas flow through the outlet. The inlet may also direct the gas to an impactor, where the impactor focuses the gas flow on to the substrate. Further, the gas flow may have particles, that are captured on a substrate configured to capture the particles. In some cases, the particles are virus particles.

Also, an embodiment of a method is described that comprises unsealing a containment assembly; coupling the containment assembly to an aerosol collector; extending a receptacle comprising a substrate into a sample chamber in the aerosol collector; exposing the substrate to a sample gas flow, wherein the sample gas flow deposits particles on the substrate; retracting the substrate into the containment assembly; decoupling the containment assembly from the aerosol collector; and sealing the containment assembly.

In some cases, the substrate is constructed of polyurethane foam and may be removeable from the receptacle. Also, the containment assembly may include a plunger mechanism configured to extend the receptacle from the housing and retract receptacle into the housing and may threadingly couple to the aerosol collector. In some instances, the housing can also threadingly couple to a cap.

The sample chamber may further be fluidically coupled to an inlet and an outlet, where the sample chamber is configured to receive a gas flow from the inlet and exhaust the gas flow through the outlet. The inlet may also direct the gas to an impactor, where the impactor focuses the gas flow on to the substrate. Further, the gas flow may have particles, that are captured on a substrate configured to capture the particles. In some cases, the particles are virus particles.

The above embodiments and implementations are not necessarily inclusive or exclusive of each other and may be combined in any manner that is non-conflicting and otherwise possible, whether they are presented in association with a same, or a different, embodiment or implementation. The description of one embodiment or implementation is not intended to be limiting with respect to other embodiments and/or implementations. Also, any one or more function, step, operation, or technique described elsewhere in this specification may, in alternative implementations, be combined with any one or more function, step, operation, or technique described in the summary. Thus, the above embodiment and implementations are illustrative rather than limiting.

### BRIEF DESCRIPTION OF THE DRAWINGS

The above and further features will be more clearly appreciated from the following detailed description when taken in conjunction with the accompanying drawings. In the drawings, like reference numerals indicate like structures, elements, or method steps and the leftmost digit of a reference numeral indicates the number of the figure in which the references element first appears (for example, element 110 appears first in FIG. 1). All of these conventions, however, are intended to be typical or illustrative, rather than limiting.

FIG. 1 is a functional block diagram of one embodiment of an aerosol collector instrument, with a sampling system, and is in communication with a computer;

FIG. 2 is a simplified graphical representation of one embodiment of the aerosol collector and sampling system of FIG. 1;

FIG. 3 is a simplified graphical representation of one embodiment of the sampling system of FIG. 2 with and impactor and an attached containment assembly with a receptacle;

FIG. 4 is a simplified graphical representation of one embodiment of the impactor positioned above the receptacle of FIG. 3, where the receptacle holds a substrate at a location under a nozzle of the impactor;

FIGS. 5A-C are simplified graphical representations of one embodiment of the containment assembly of FIG. 3; and

FIG. 6 is a functional block diagram of one embodiment of a method for using aerosol collector instrument with a containment assembly to collect particle samples from the air while maintaining protecting a user from exposure.

Like reference numerals refer to corresponding parts throughout the several views of the drawings.

### DETAILED DESCRIPTION OF EMBODIMENTS

As will be described in greater detail below, embodiments of the described invention include a system configured to capture aerosolized particles from a gas and minimize user exposure to the particles. More specially the particles may include biological material such as viral particles or bacterial particles, and the gas may include ambient air, breath from a living organism, or other gas that may include aerosolized biological material.

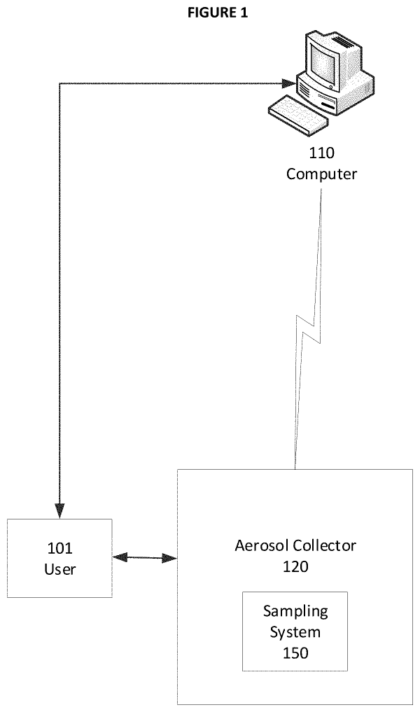

FIG. 1 provides a simplified illustrative example of user 101 capable of interacting with computer 110 and aerosol collector 120 with sampling system 150. Embodiments of aerosol collector 120 may include any commercially available instruments configured for collecting particles from a gas. Those of ordinary skill in the art appreciate that aerosol collector 120 may include a number of elements such as one or more pumps to create a gas flow that draws in air from the environment surrounding aerosol collector 120. Aerosol collector may also include control electronics and a variety of other components known to those of ordinary skill in the art. For example, aerosol collector 120 may include the ASAP 2800 or AEROSENSE instruments available from Thermo Fisher Scientific.

FIG. 1 also illustrates a network connection between computer 110 and aerosol collector 120, however it will be appreciated that FIG. 1 is intended to be exemplary and some embodiments of aerosol collector 120 may not require computer 110 or a network connection, or that additional or fewer network connections may be included. Further, the network connection between the elements may include “direct” wired or wireless data transmission (e.g. as represented by the lightning bolt) as well as “indirect” communication via other devices (e.g. switches, routers, controllers, computers, etc.) and therefore the example of FIG. 1 should not be considered as limiting.

Computer 110 may include any type of computing platform such as a workstation, a personal computer, a tablet, a “smart phone”, one or more servers, compute cluster (local or remote), or any other present or future computer or cluster of computers. It will also be appreciated that the computer 110 may be integrated within the aerosol collector 120 rather than provided as a separate device. Computers typically include known components such as one or more processors, an operating system, system memory, memory storage devices, input-output controllers, input-output devices, and display devices. It will also be appreciated that more than one implementation of computer 110 may be used to carry out various operations in different embodiments, and thus the representation of computer 110 in FIG. 1 should not be considered as limiting.

In some embodiments, computer 110 may employ a computer program product comprising a computer usable medium having control logic (e.g. computer software program, including program code) stored therein. The control logic, when executed by a processor, causes the processor to perform some or all of the functions described herein. In other embodiments, some functions are implemented primarily in hardware using, for example, a hardware state machine. Implementation of the hardware state machine so as to perform the functions described herein will be apparent to those skilled in the relevant arts. Also in the same or other embodiments, computer 110 may employ an internet client that may include specialized software applications enabled to access remote information via a network. A network may include one or more of the many types of networks well known to those of ordinary skill in the art. For example, a network may include a local or wide area network that may employ what is commonly referred to as a TCP/IP protocol suite to communicate. A network may include a worldwide system of interconnected computer networks that is commonly referred to as the internet, or could also include various intranet architectures. Those of ordinary skill in the related art will also appreciate that some users in networked environments may prefer to employ what are generally referred to as “firewalls” (also sometimes referred to as Packet Filters, or Border Protection Devices) to control information traffic to and from hardware and/or software systems. For example, firewalls may comprise hardware or software elements or some combination thereof and are typically designed to enforce security policies put in place by users, such as for instance network administrators, etc.

As described herein, embodiments of the described invention include an automated solution to isolate substrate material from an instrument used to capture particles from a gas, and protect the user from contact with the isolated material. Importantly, the solution substantially eliminates human contact with the substrate, preserving the integrity of the collected sample and protecting individuals from potentially harmful pathogens.

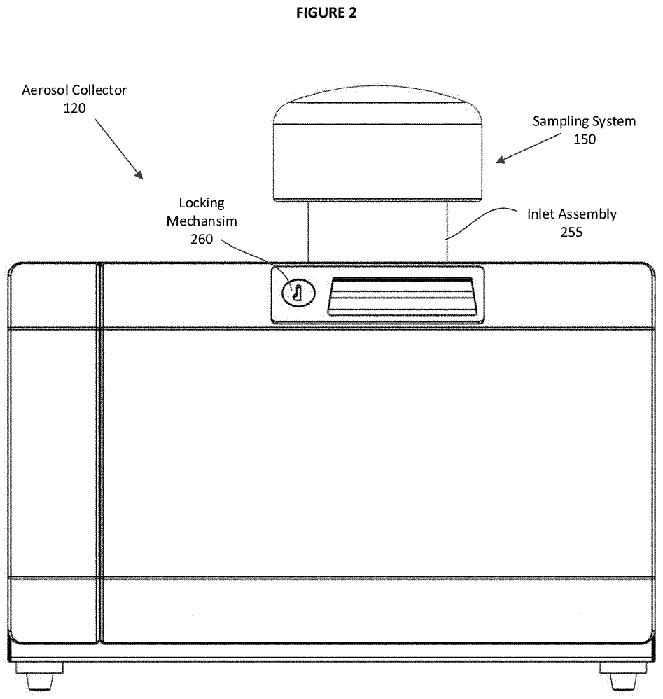

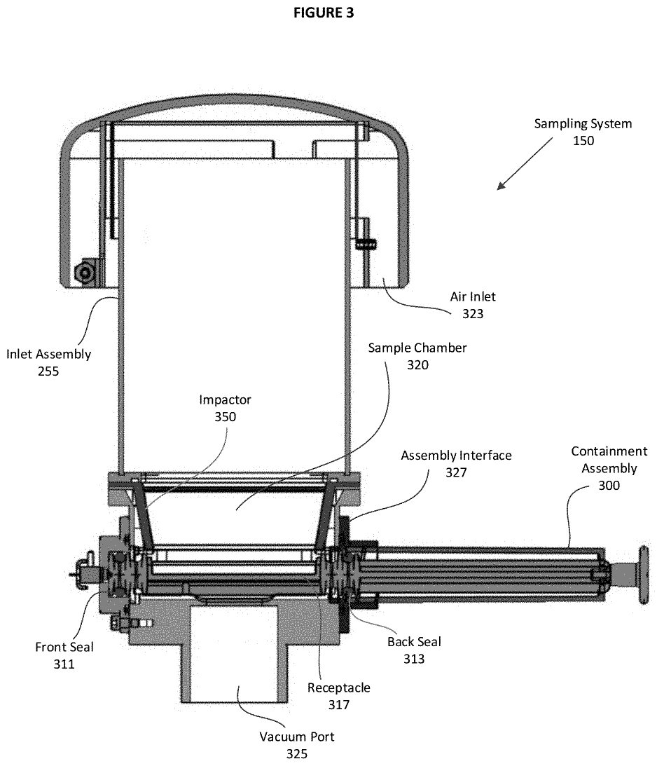

FIG. 2 provides a simplified illustrative example of aerosol collector 120 with a portion of sampling system 150 extending from the top. For example, sampling system 150 may include inlet assembly 255 that has a chimney-like extension with a cap shape configured to provide separation for air intake from the main body of aerosol collector 120. Also included in this example is a locking mechanism 260 to prevent unauthorized access to the system. FIG. 3 provides a cutaway view from a side of sampling system 150 with inlet assembly 255.

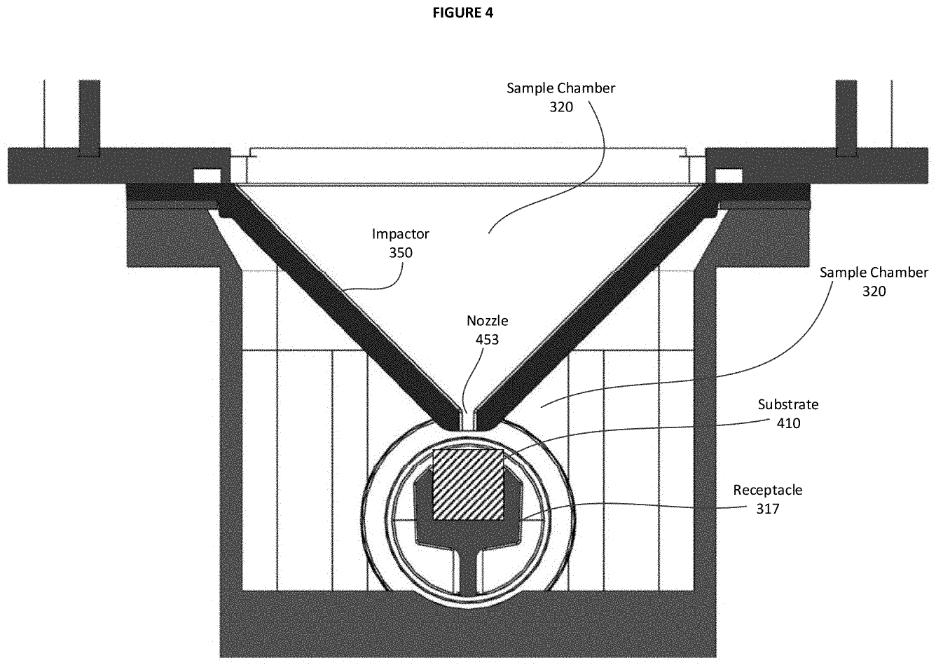

FIG. 3 further illustrates air inlet 323 configured to draw in ambient air from the environment surrounding aerosol collector 120 and into sample chamber 320, where the air is directed as a flow of sample gas through impactor 350 towards receptacle 317 that is part of containment assembly 300. Impactor 350 is located within sample chamber 320 and is configured to concentrate a flow of the sample gas, typically containing particles sampled from the ambient environment at a location. FIG. 4 illustrates a close up view of impactor 350 looking from the end of containment assembly 300 and shows a positional relationship of nozzle 453 within sample chamber 320 and located above substrate 410 that is held in place by receptacle 317. The flow of sample gas impacts with substrate 410, depositing particles onto the surface of and/or into the material of substrate 410, whereupon the flow of sample gas exits through vacuum port 325, substantially without the particles.

Importantly, sampling system 150 is enabled to maintain the flow of sample gas, and the particles contained therein, in isolation so that user 101 does not come into contact with the particles, particularly the concentrated particles, or the flow of sample gas. For example, containment assembly 300 is configured to reversibly introduce and extract receptacle 317 with substrate 410 from sampling system 150. Containment assembly 300 includes front seal 311 and back seal 313 that creates a gas tight seal with sampling system 150 (e.g. “sealingly” engages with sampling system 150) when receptacle 317 is in an “extended” conformation (e.g. as illustrated in FIG. 3), properly positioning substrate 410 in sample chamber 320 relative to nozzle 453 (e.g. as illustrated in FIG. 4). Sampling system 150 also includes assembly interface 327 that engages with containment assembly 300 (e.g. a threaded engagement also referred to as “threadingly” engages, or other type of mechanical engagement known in the art) to promote the gas tight seal and proper position. For example, assembly interface 327 may be configured so that it only allows engagement with containment assembly 300 in a way that properly positions receptacle 317 and substrate 410 relative to nozzle 453.

Substrate 410 may include a variety of materials configured to capture particles of interest and subsequently easily release the particles for analysis. Further, in some embodiments substrate 410 may include a substance or combination of substances configured to enhance capture and/or release of particles, stabilize biological particles, and/or enhance the viability of biological particles (e.g. the substance may be coated onto and/or impregnated into substrate 410). For example, substrate 410 may include polyurethane foam, porous polymers, “flocked swab”, glass or ceramic media, sintered material, electrically charged conductive media, or other substance known in the art. Also, the substance or combination of substances may include a liquid or gel disposed on the surface of substrate 410, and/or impregnated into the material of substrate 410, that may act to capture particles and improve the efficiency of processing and/or improve the biological viability of particles.

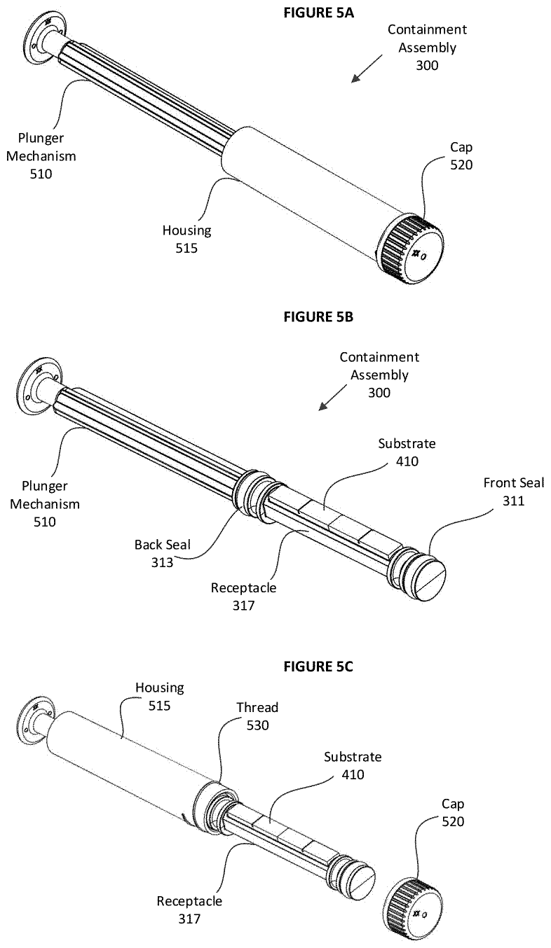

FIGS. 5A-C provide illustrative examples of various positional conformations and elements associated with containment assembly 300. For example, FIG. 5A illustrates a “retracted” conformation where substrate 410 (not shown) is retracted into and protected by housing 515. Also, cap 520 is positioned to enclose the open end of housing 515, isolating substrate 410 in a chamber within the interior of housing 515. FIG. 5A additionally illustrates plunger mechanism 510 that may include ribs or other elements that act as a key that fits complementary structure on the end of housing 515 (not shown). Thus, the interaction between the key elements and complementary housing structure acts to properly orient receptacle 317 and substrate 410 relative to housing 515.

FIG. 5B provides an illustrative example of containment assembly 300 with housing 515 removed so that the positional arrangement of receptacle 317 and substrate 410 is shown along with back seal 313 and front seal 311. Those of ordinary skill in the art will appreciate that back seal 313 and front seal 311 sealingly engage with housing 515 in the retracted conformation creating a gas tight environment within the chamber within the interior of housing 515.

FIG. 5C provides an illustrative example of containment assembly 300 in an “extended” conformation where substrate 410 is extended outside of housing 515. Those of ordinary skill in the art will appreciate that cap 520 should first be removed from housing 515 before pressing plunger mechanism 510 while holding housing 515 to extend receptacle 317 and substrate beyond the end of housing 515. FIG. 5C also illustrates thread 530 configured to engage with cap 520 as well as assembly interface 327.

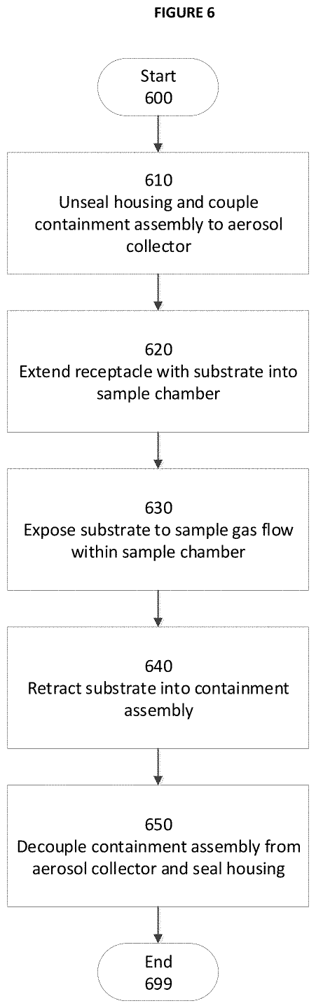

FIG. 6 provides an illustrative example of a method for using aerosol collector 120 with containment assembly 300 to collect particle samples from the air while maintaining isolation to protect user 101 from exposure. For example, in step 610, user 101 unseals housing 515 by removing cap 520, and threadingly couples housing 515 to assembly interface 327 of sampling system 150. Next, in step 620 user 101 presses plunger mechanism 510 to extend receptacle 317 with substrate 410 into a conformation that properly positions substrate 410 relative to nozzle 453 for efficient collection of particles. Then, in step 630 user 101 activates aerosol collector 120 into a mode that draws air through air inlet 323, into sample chamber 320, past substrate 410 via impactor 350, and out vacuum port 325. Once aerosol collector 120 has run in the collection mode for a desired period of time, the operation mode is discontinued and user 101 pulls on plunger mechanism to retract receptacle 317 with substrate 410 into housing 515, as illustrated in step 640. Last, as illustrated in step 650, user 101 decouples housing 515 from assembly interface 327 and seals housing 515 with cap 520 (e.g. thread cap 520 to housing 515.). Substrate 410 can then be removed from receptacle 317 and analyzed for the particles by an appropriate method for particle detection (e.g. Polymerase Chain Reaction (PCR) for viral particles).

Having described various embodiments and implementations, it should be apparent to those skilled in the relevant art that the foregoing is illustrative only and not limiting, having been presented by way of example only. Many other schemes for distributing functions among the various functional elements of the illustrated embodiments are possible. The functions of any element may be carried out in various ways in alternative embodiments

What is claimed is:

1. A system, comprising:
a containment assembly comprising a receptacle configured to hold a substrate, wherein the containment assembly is configured to extend the receptacle from a housing and retract receptacle into the housing; and
an aerosol collector comprising a sample chamber, wherein the aerosol collector is configured to operatively couple to the containment assembly and receive the extended receptacle with the substrate in the sample compartment.

2. The assembly of claim 1, wherein:
the substrate is constructed of polyurethane foam.

3. The assembly of claim 1, wherein:
the substrate is removeable from the receptacle.

4. The assembly of claim 1, wherein:
the containment assembly comprises a plunger mechanism configured to extend the receptacle from the housing and retract receptacle into the housing.

5. The assembly of claim 1, wherein:
the containment assembly threadingly couples to the aerosol collector.

6. The assembly of claim 1, wherein:
the containment assembly comprises a cap that threadingly couples to the housing.

7. The assembly of claim 1, wherein:
the sample chamber is fluidically coupled to an inlet and an outlet, wherein the sample chamber is configured to receive a gas flow from the inlet and exhaust the gas flow through the outlet.

8. The assembly of claim 7, wherein:
the inlet directs the gas to an impactor, wherein the impactor focuses the gas flow on to the substrate.

9. The assembly of claim 1, wherein:
the gas flow comprises particles, wherein that substrate is configured to capture the particles.

10. The assembly of claim 1, wherein:
the particles comprise virus particles

11. A method, comprising:
unsealing a containment assembly;
coupling the containment assembly to an aerosol collector;
extending a receptacle comprising a substrate into a sample chamber in the aerosol collector;
exposing the substrate to a sample gas flow, wherein the sample gas flow deposits particles on the substrate;
retracting the substrate into the containment assembly;
decoupling the containment assembly from the aerosol collector; and
sealing the containment assembly.

12. The method of claim 11, wherein:
the substrate is constructed of polyurethane foam.

13. The method of claim 11, wherein:
the substrate is removeable from the receptacle.

14. The method of claim 11, wherein:
the containment assembly comprises a plunger mechanism configured to extend the receptacle from the housing and retract receptacle into the housing.

15. The method of claim 11, wherein:
the containment assembly threadingly couples to the aerosol collector.

16. The method of claim 11, wherein:
the containment assembly comprises a cap that threadingly couples to the housing.

17. The method of claim 11, wherein:
the sample chamber is fluidically coupled to an inlet and an outlet, wherein the sample chamber is configured to receive a gas flow from the inlet and exhaust the gas flow through the outlet.

18. The method of claim 17, wherein:
The inlet directs the gas to an impactor, wherein the impactor focuses the gas flow on to the substrate.

19. The method of claim 11, wherein:
the gas flow comprises particles, wherein that substrate is configured to capture the particles.

20. The method of claim 11, wherein:
the particles comprise virus particles
